(19) United States
(12) Patent Application Publication
(10) Pub. No.: US 2017/0136930 A1
(43) Pub. Date: May 18, 2017

(54) PORTABLE CUP HOLDER SYSTEMS

(71) Applicant: Derek Wade Corse, Edmonton (CA)

(72) Inventor: Derek Wade Corse, Edmonton (CA)

(21) Appl. No.: 14/941,692

(22) Filed: Nov. 16, 2015

(51) Int. Cl. B60N 3/10; A45F 5/10

(52) U.S. Cl. CPC B60N 3/103; A45F 5/10; A45F 2200/0583

(57) ABSTRACT

A portable cup holder system for transporting one or more beverage containers. Portable cup holder systems may include a receiver body and a carrying member. The receiver body may accept at least one beverage-style container and may be removably inserted in a vehicle-cup-holder by anyone who has a requirement to transport one or more beverages simultaneously. The portable cup holder system may be inserted and removed from a vehicle-cup-holder by engaging with a hingeably-attached carrying member adjacent to the receiver body. A plurality of portable cup holder systems may be removably coupled in a manner to allow a user to carry additional beverage-style containers in a practical manner. To enable convenience and efficiency in storing portable cup systems, portable cup holder system is structured and arranged to be collapsible for efficient stackable storage purposes.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of transporting one or more beverage containers and more specifically relates to portable cup holder systems.

### 2. DESCRIPTION OF RELATED ART

People are often “on-the-go,” whether they are going to work, school, the gym, or any number of other activities. It is natural to want to have one or more beverages to hydrate, caffeinate, or otherwise just enjoy while out and about. People may wish to purchase beverages for others (co-workers, friends, or the like) which may prove difficult given conventional means for transport. While “on-the-go”, one way to obtain beverages is to stop at a store and purchase beverages in portable containers. Another method is to access a drive-through at a restaurant or business that conveniently provides drinks in a manner where consumers can obtain the beverages without the need to exit their vehicle. For consumers driving a vehicle, cup holders placed around the interior of the vehicle may be used as receptacles to hold the beverages in their containers while en route.

Both vehicle cup holders and the beverages they hold are designed to be mutually beneficial in that diverse, transportable beverages are generally held in containers that usually fit in to vehicle cup holders, creating a convenience for consumers. However, many convenience beverage containers have no handles on them to facilitate carrying them. After arriving at the destination, if a consumer has brought multiple beverages and anything else such as sports equipment, food, or a purse, it may be difficult to carry all of the items at once without dropping an item or spilling a beverage.

Several attempts have been made to solve the above-mentioned problems such as those found in U.S. Pub. Nos. 2007/0125912 to Wright, and 2012/0018469 to Fisher; U.S. Pat. No. 3,712,235 to Russ, U.S. Pat. No. 4,248,397 to Casper, U.S. Pat. No. 5,072,909 to Huang, U.S. Pat. No. 5,280,870 to Chick et. al., U.S. Pat. No. 8,360,379 to Porcelli, U.S. Pat. No. 5,361,950 to Signal et. al, U.S. Pat. No. 7,533,860 to Somuah; CA Pat. No. 2,097,764 to Peck; CN Pat. No. 202,686,061 to Zhang Bing et. al., 203,681,358 to Zhou Xiaoqing, 204,055,493 to Now Yang We et. al., 204,196,755 to Meng Na et. al., 204,399,862 to Xiangkun; EP Pat. No. 0,320,794 to Winter; JP Pat. No. 2005/021545 to Ueno et. al; and WO Pat. No. 1996/041729 to Christian, et. al. This art is representative of vehicle cup holder systems. However, none of the above inventions and patents, taken either singly or in combination, is seen to describe the invention as claimed.

Preferably, a means for transporting one or more beverage containers should provide a convenient means to carry beverage containers and, yet would operate reliably and be manufactured at a modest expense. Thus, a need exists for a reliable portable cup holder system to avoid the above-mentioned problems.

### BRIEF SUMMARY OF THE INVENTION

In view of the foregoing disadvantages inherent in the known means for transporting one or more beverage containers art, the present invention provides a novel portable cup holder system. The general purpose of the present invention, which will be described subsequently in greater detail is to provide a convenient assembly to carry beverage containers.

Portable cup holder systems in a preferred embodiment is described herein comprising a receiver body (preferably) comprising non-porous material and a carrying member. The receiver body may accept at least one beverage-style container and may be removably inserted in a vehicle-cup-holder with a plurality of cup receivers by anyone who has a requirement to transport one or more beverage containers simultaneously, placing at least one beverage-style container into a receiver body of the portable cup holder. The portable cup holder system may either be carried or be removably inserted in a vehicle-cup-holder, with minimal effort, by employing a hingeably-attached carrying member that is adjacent to the receiver body. A plurality of portable cup holder systems may be removably coupled in a modular manner to allow a user to carry additional beverage-style containers in an expedient manner. To enable convenience and efficiency in storing portable cup holder systems, portable cup holder systems is structured and arranged to be collapsible for efficient stackable storage purposes. Modular means may be enabled via snap-together relationships or the like.

Further, receiver body comprising at least one inner volume, an outer surface, a thickness, may further comprise at least one set of legs; the at least one set of legs useful for vertical elevation and stabilization of the receiver body on planar surfaces such as the ground or a picnic table for example.

The present invention holds significant improvements and serves as a portable cup holder system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, portable cup holder systems, constructed and operative according to the teachings of the present invention.

FIG. 1 shows a perspective view illustrating a portable cup holder system during an ‘in-use’ condition showing a portable cup holder according to an embodiment of the present invention.

FIG. 2 is a perspective view illustrating the portable cup holder according to an embodiment of the present invention of FIG. 1.

FIG. 3 is an exploded view illustrating the portable cup holder system according to an embodiment of the present invention of FIGS. 1-2.

FIG. 4 is a perspective view illustrating an additional embodiment of the portable cup holder systems according to an embodiment of the present invention of FIGS. 1-3.

FIG. 5 is a flowchart illustrating a method of use for the portable cup holder systems according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to transporting one or more beverage containers and more particularly to a portable cup holder system as used to improve convenience for carrying beverage containers between locations.

Generally speaking, portable cup holder systems may resemble a receiver body and a carrying member, as previously mentioned. The receiver body of portable cup holder systems may be removably inserted in a vehicle-cup-holder having a plurality of cup receivers by anyone who has one or more beverage containers to transport in a convenient manner. The receiver body may accept at least one object such as a hot beverage-style cup, a cold beverage-style cup, a can-container, or a bottle-container. The portable cup holder system may be inserted and removed from a vehicle-cup-holder with minimal effort by employing the carrying member which is preferably hingeably attached to the receiver body. Additional useability of portable cup holder systems is gained by removably coupling portable cup holder systems with cup holders available on boats, airplanes, all-terrain vehicles, and theater-style seating systems.

Further, a plurality of portable cup holder systems may be removably coupled in a modular manner to allow a user to carry additional beverage-style containers in an expedient manner. To enable convenience and efficiency in storing portable cup holder systems, portable cup holder systems is structured and arranged to be collapsible for efficient stackable storage purposes. When collapsed the device comprises a substantially flat profile.

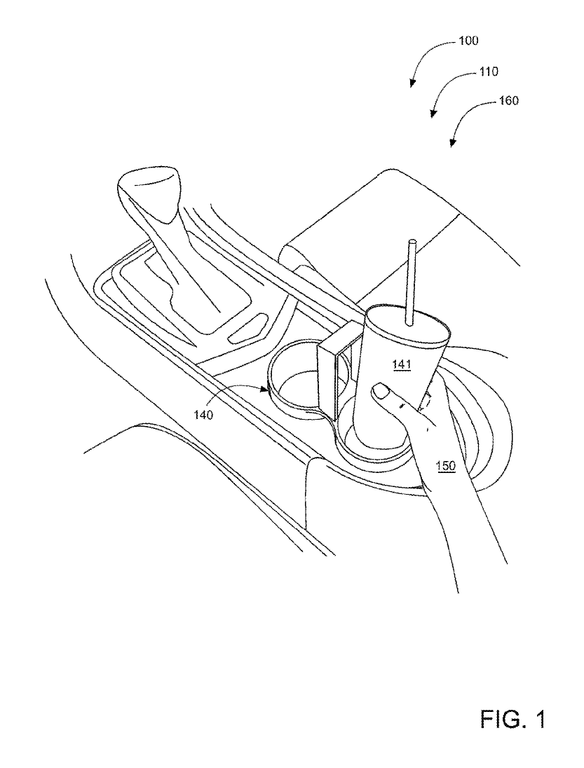

Referring to the drawings by numerals of reference there is shown in FIG. 1, a perspective view illustrating a portable cup holder system 100 in an ‘in use’ condition 160 showing a portable cup holder 110 installed in vehicle-cup-holder 140 wherein user 150 may removably insert beverage style container 141 according to an embodiment of the present invention.

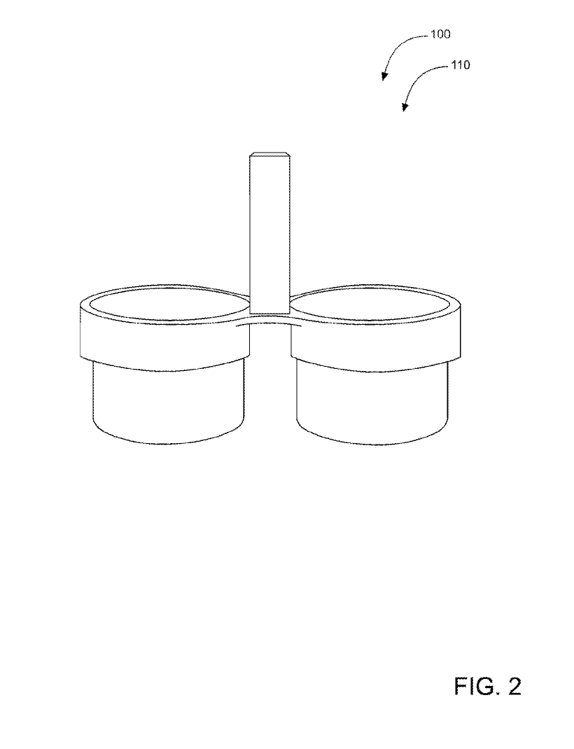

Referring now to FIG. 2, a perspective view illustrating portable cup holder system 100 comprising portable cup holder 110 according to an embodiment of the present invention. Portable cup holder 110 is able to be removably coupled in a modular manner to another portable cup holder 110, thus increasing the quantity of beverage containers that may be carried at a time. Portable cup holder 110 is structured and arranged to be stable and remain upright when removed from vehicle-cup-holder and placed on a flat planar surface.

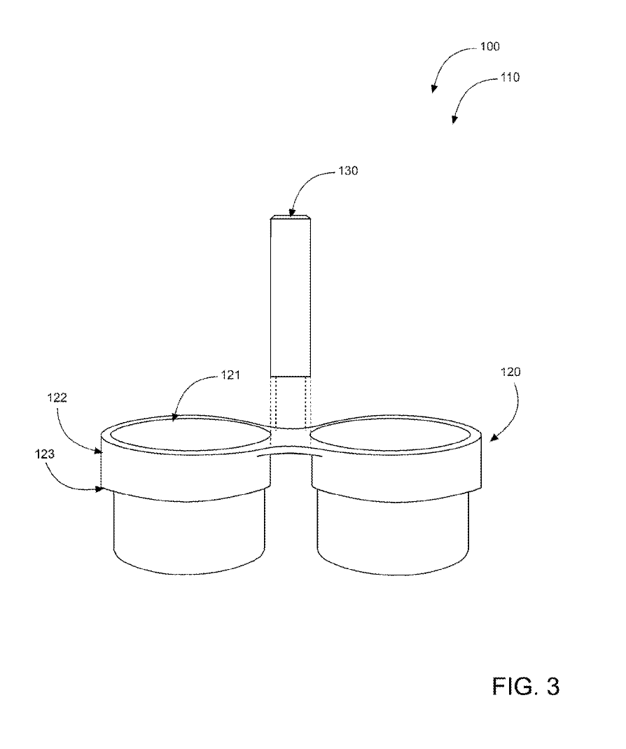

Referring now to FIG. 3, an exploded view illustrating portable cup holder system 100 comprising portable cup holder 110 comprising carrying member 130 and receiver body 120. Receiver body 120 is able to be carried by carrying member 130 as carrying member 130 is structured and arranged to be in communication with receiver body 120. Further, receiver body 120 is removably insertable into a vehicle-cup-holder having a plurality of cup receivers and is capable of transporting at least one retainable object in the form of a hot beverage-style cup, a cold beverage-style cup, and a can- or bottle-container.

In continuing to define the parameters of portable cup holder system 100, portable cup holder 110 receiver body 120 is defined by at least one inner volume 121, outer surface 122, and thickness 123. Receiver body 120 in preferred embodiments comprises a cylindrical configuration with a flat bottom suitable for steadying beverage-container(s) inserted into at least one inner volume 121. Thickness 123 of receiver body 120 may comprise insular properties suitable for sustaining a desired temperature of liquid contained in beverage-container inserted into at least one inner volume 121. Further, receiver body 120 is constructed of non-porous materials that are resistant to corrosion from moisture and allow for repeated cleaning for sanitization purposes.

Referring further to FIG. 3, at least one inner volume 121 of receiver body 120 is able to independently accept at least one beverage-style container to enable storage in a vehicle for ready consumption. At least one inner volume 121 securely accepts a plurality of beverage-container-sizes, which is useful for transporting liquids in a stabilized and protected manner. At least one inner volume 121 of receiver body 120 accepts at least one hot beverage-style cup to allow an operator to safely store a hot-beverage while driving, at least one cold beverage-style cup to enable storage of a cold-beverage in a vehicle, a can-container and, alternately, a bottle-container. Further, at least one inner volume 121 of receiver body 120 retains spilled liquid and condensation to maintain cleanliness of a vehicle-interior.

Carrying member 130 may be hingeably attached to receiver body 120 to allow unobstructed access to a beverage-container retained in at least one inner volume 121. Carrying member 130 is structured ergonomically to increase a user's comfort via an intuitive design that supports natural body mechanics to reduce hand and finger fatigue of a user while carrying portable cup holder 110 when portable cup holder 100 is in an unengaged condition relative to vehicle-cup-holder. Upon reading this specification, it should be appreciated that, under appropriate circumstances, considering such issues as user preferences, design preference, structural requirements, marketing preferences, cost, available materials, technological advances, etc., other beverage container arrangements such as, for example, including more or less components, customized parts, different carrying options such as non-hinged, parts may be sold separately, etc., may be sufficient.

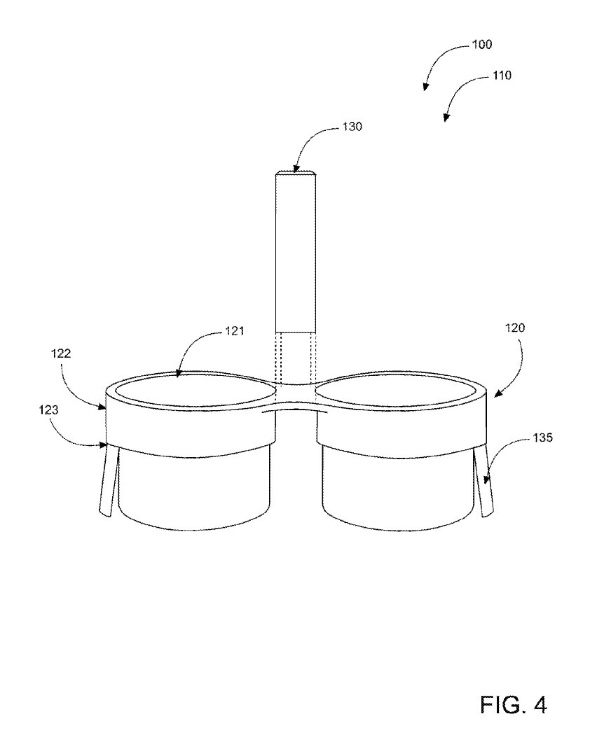

Referring now to FIG. 4, illustrating a further embodiment of the present invention, portable cup holder system 100, portable cup holder 110 comprising receiver body 120, at least one inner volume 121, outer surface 122, and thickness 123, and carrying member 130 are further stabilized by legs 135 comprising tip-resistant structure when portable cup holder system 100 is removed from vehicle-cup-holder and placed on a flat planar surface such as the ground or a table or the like. A kit may be used wherein a plurality of portable cup holders 110 may be sold to be used modularly, having instructions for use.

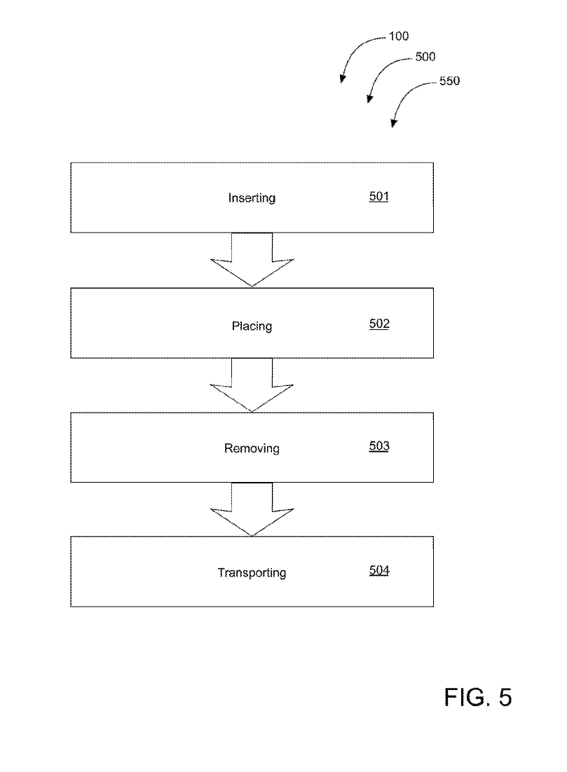

Referring now to FIG. 5 showing flowchart 550 illustrating method of use 500 for portable cup holder system 100 according to an embodiment of the present invention of FIGS. 1-4. As shown, method of use 500 may comprise the steps of: step one 501, inserting portable cup holder 110 into vehicle-cup-holder 140, placing at least one beverage-style container 141 into a receiver body 120 of portable cup holder 110, removing portable cup holder 110 from vehicle-cup-holder 140, and transporting beverages in portable cup holder 110.

It should be noted that the steps described in the method of use can be carried out in many different orders according to user preference. The use of “step of” should not be interpreted as “step for”, in the claims herein and is not intended to invoke the provisions of 35 U.S.C. §112, §6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A portable cup holder system comprising:
a portable cup holder comprising;
a receiver body comprising;
at least one inner volume;
an outer surface; and
a thickness; and
a carrying member;
wherein said portable cup holder system comprises said portable cup holder;
wherein said portable cup holder comprises in structural combination said carrying member and said receiver body, said receiver body able to be carried by said carrying member;
wherein parameters of said receiver body are defined by said at least one inner volume, said outer surface, and said thickness;
wherein said carrying member is in communication with said receiver body;
wherein said receiver body is structured and arranged to be removably insertable into a vehicle-cup-holder having a plurality of cup receivers; and
wherein said receiver body is useful for removably inserting into said vehicle-cup-holder to transport at least one retainable object.

2. The portable cup holder system of claim 1 wherein said portable cup holder is structured and arranged to be collapsible for efficient stackable storage purposes.

3. The portable cup holder system of claim 1 wherein said at least one inner volume of said receiver body is able to independently accept at least one beverage-style container to enable storage of said at least one beverage-style container in a vehicle for ready consumption.

4. The portable cup holder system of claim 1 wherein said at least one inner volume of said receiver body accepts at least one hot beverage-style cup to allow an operator to safely store a hot-beverage while driving.

5. The portable cup holder system of claim 1 wherein said at least one inner volume of said receiver body accepts at least one cold beverage-style cup to enable storage of a cold-beverage in a vehicle.

6. The portable cup holder system of claim 1 wherein said at least one inner volume of said receiver body provides removable storage for a can-container and alternately a bottle-container.

7. The portable cup holder system of claim 1 wherein said at least one inner volume of said receiver body retains spilled liquid and condensation to maintain cleanliness of a vehicle-interior.

8. The portable cup holder system of claim 1 wherein said carrying member is structured ergonomically to reduce hand and finger fatigue of a user while carrying said portable cup holder when said portable cup holder is in an unengaged condition relative to said vehicle-cup-holder.

9. The portable cup holder system of claim 8 wherein said carrying member is hingeably attached to said receiver body to allow unobstructed access to a beverage-container retained in said at least one inner volume.

10. The portable cup holder system of claim 9 wherein said thickness of said receiver body provides insular properties suitable for sustaining a desired temperature of liquid contained in said beverage-container inserted into said at least one inner volume.

11. The portable cup holder system of claim 10 wherein said receiver body of said portable cup holder comprises a cylindrical configuration with a flat bottom suitable for steadying said beverage-container inserted into said at least one inner volume.

12. The portable cup holder system of claim 1 wherein said portable cup holder is able to be removably coupled modularly to another said portable cup holder thus increasing quantity of said containers that can be carried at once.

13. The portable cup holder system of claim 1 wherein said receiver body of said portable cup holder is resistant to corrosion from moisture.

14. The portable cup holder system of claim 1 wherein said receiver body of said portable cup holder comprises non-porous materials and is repeatedly cleanable for sanitization purposes.

15. The portable cup holder system of claim 1 wherein said at least one inner volume of said receiver body securely accepts a plurality of beverage-container-sizes useful for transporting liquids in a stabilized and protected manner.

16. The portable cup holder system of claim 1 wherein said portable cup holder is structured and arranged to be stable and remain upright when removed from a vehicle and placed on a flat planar surface.

17. A portable cup holder system comprising:
a receiver body comprising non-porous material, said receiver body comprising at least one inner volume, an outer surface, a thickness, and at least one set of legs, said at least one set of legs useful for vertical elevation and stabilization of said receiver body; and
a carrying member;
wherein said portable cup holder system comprises said portable cup holder;
wherein said portable cup holder system comprises in structural combination said carrying member and said receiver body, said receiver body able to be carried by said carrying member;
wherein parameters of said receiver body are defined by said at least one inner volume, said outer surface, and said thickness;
wherein said carrying member is in communication with said receiver body;
wherein said receiver body is structured and arranged to be removably insertable into a vehicle-cup-holder having a plurality of cup receivers; and
wherein said receiver body is useful for removably inserting into said vehicle-cup-holder to transport at least one retainable object.

18. The portable cup holder system of claim 17 further comprising a kit including:
said at least one portable cup holder system; and
wherein said at least one portable cup holder system(s) are modularly stackable.

19. A method of using a portable cup holder system comprising the steps of:
inserting a portable cup holder into a vehicle-cup-holder;
placing at least one beverage-style container into a receiver body of said portable cup holder;
removing said portable cup holder from said vehicle-cup-holder; and
transporting beverages in said portable cup holder.

20. The method of claim 19 further comprising the optional steps of:
modularly arranging said at least one portable cup holder as desired;
collapsing said at least one portable cup holder; and
stackably-storing said at least one portable cup holder.
